(19) United States
(12) Patent Application Publication
(10) Pub. No.: US 2012/0262576 A1
(43) Pub. Date: Oct. 18, 2012

(54) Method And System For A Network Of Multiple Live Video Sources

(76) Inventors: Andrew Blough Sechrist, San Francisco, CA (US); Vladan Djakovic, San Francisco, CA (US); Ognjen Sami, Beograd (RS); William John Delveaux, San Jose, CA (US); Jonathan Daniel Mendelson, San Carlos, CA (US)

(21) Appl. No.: 13/421,053

(22) Filed: Mar. 15, 2012

Related U.S. Application Data
(60) Provisional application No. 61/517,096, filed on Apr. 14, 2011.

(51) Int. Cl. H04N 7/18; H04N 5/76; H04N 21/60

(52) U.S. Cl. 348/143; 725/109; 348/231.3; 348/E07.085; 348/E05.031

(57) ABSTRACT

A system and a method operate a network of multiple live video sources. The system may include (i) a device server for communicating with one or more of the video sources each providing a video stream; (ii) an application server to allow controlled access of the network by qualified web clients; and (iii) a streaming server which, under direction of the application server, routes the video streams from the one or more video sources to the qualified web clients.

### CROSS-REFERENCE TO RELATED APPLICATIONS

This patent application claims priority to and is related to U.S. Provisional Patent Application No. 61/517,096 entitled “A Method of Certifying Location and Time of Live Video Sources,” by Andrew Sechrist and Vladan Djakovic, filed on Apr. 14, 2011; the content of which is hereby incorporated by reference in its entirety.

### BACKGROUND

1. Field of the Invention

Embodiments described herein relate to networked sensors. More particularly, embodiments described herein are related to networked video sources that can be accessed through a network streaming service.

2. Description of Related Art

Hardware and software used to setup and manage networked systems have advanced considerably. Web servers now typically operate in a massively parallel fashion, and storage continues to increase in size and decrease in cost. Faster switches using advanced routing techniques have become pervasive, while the bandwidth of data transmission also keeps increasing. Such technological advances have created opportunities for sharing large amounts of information over an ever-increasing network. Concurrently, increasingly sophisticated techniques for analyzing the shared information provide valuable metrics. Furthermore, many networked systems have the capability of reporting their geographic locations with precision.

In the prior art, a typical online application or service that includes one or more embedded video streams is supported by a single broadcasting entity or publisher. Such an application or service seldom involves a large number of live video sources (e.g., cameras). In another prior art application, multiple users may upload video content to a network, to be viewed at later times by other users. However, in such an application, the video content is fixed, and does not provide real-time information of current events. Furthermore, many existing online video applications allow the general public to broadcast or view their contents without restrictions, such that there is little or no content supervision or user management. Such applications expose broadcasting users to risk and viewers to unwanted content. Moreover, in current video sharing networks, there is little or no capability for the content creator or broadcaster to derive value from the video broadcast.

The Internet has facilitated broadcast of recorded and live video content. However, in current systems and applications, a consumer cannot readily determine whether or not a particular video stream is live. When the video stream is not live, the consumer cannot readily determine when the video stream was recorded. Similarly, it is difficult to determine where the events in the video stream take place, or were recorded. The uncertainty in such information diminishes the value of all video sources, as their origin may not be determined, nor can fabricated video sources be identified. Therefore, both viewers and broadcasters are penalized. As a result, the perceived value of a current online video stream depends on the trustworthiness of the publisher, which must be built up over time with a sizeable viewership. Many potentially useful sources are thus left out of this ‘trust’ domain. Indeed, particular individuals and small entities may provide valuable video streams but have no easy way of establishing their trustworthiness without sponsorship of established publishers, who may extract onerous contract agreements from these individuals or small entities.

What is needed is a secured and managed environment to allow users or viewers to access networked video sources to share live content or information.

### SUMMARY

A system and a method are provided to operate a network of multiple live video sources. In one embodiment, the system includes (i) a device server for communicating with one or more of the video sources each providing a video stream; (ii) an application server to allow controlled access of the network by qualified web clients; and (iii) a streaming server which, under direction of the application server, routes the video streams from the one or more video sources to the qualified web clients.

According to some embodiments of the present invention, a network for multiple live video sources takes advantage of the above technological progress to provide a venue for broadcasters and users to exchange valuable information. Such a network, for example, enables sharing live video content from multiple sources with multiple viewers. The video content is easily broadcast and accessed using standard consumer electronic devices (e.g., cameras on mobile telephones). A viewer registered to the network may select any video stream from a large number of available video streams, each video stream originating at a different location, which may be broadcast by a different user. Further, according to some embodiments, a viewer registered in the network may access statistical and geographical data associated with each live video source. In addition, third party advertisers may introduce relevant advertising in web pages served to the viewers registered to the network. The advertisements may be designed according to the video content that is viewed and collected statistics of viewing habits and other metrics.

In some embodiments, a broadcaster registered with the network may place a feed from one or more registered cameras on a specific web page. The broadcaster may include a link to the feed in an e-mail to a potential viewer.

These and other embodiments of the present invention will be described in further detail below with reference to the following drawings.

### BRIEF DESCRIPTION OF THE DRAWINGS

FIG. 1 illustrates a system for networking multiple live video sources, according to some embodiments of the present invention.

FIG. 2A illustrates a camera server coupled to multiple remote cameras, according to some embodiments of the present invention.

FIG. 2B illustrates a server configured to manage multiple networked live video sources and allowing client access through web interfaces, according to some embodiments of the present invention.

FIG. 2C illustrates a streaming server configured to stream video data from multiple live video sources, according to some embodiments of the present invention.

FIG. 2D illustrates a tamper proof remote camera system according to some embodiments of the present invention.

FIG. 3A illustrates a graphical display used in a networking application running on a remote camera, according to some embodiments of the present invention.

FIG. 3B illustrates a display of a web interface for a networking application running on a client device, according to some embodiments of the present invention.

FIG. 4 is a flow chart of a method for operating a server configured to stream video data from multiple live video sources, according to some embodiments of the present invention.

FIG. 5 is a flow chart of a method for managing users in a network for multiple live video sources, according to some embodiments of the present invention.

FIG. 6 is a flow chart of a method for verifying a client status in a network for multiple live video sources, according to some embodiments of the present invention.

FIG. 7 is a flow chart of a method for verifying a stream status in a network for multiple live video sources, according to some embodiments of the present invention.

FIG. 8 is a flow chart of a method for performing client and stream interactions in a network for multiple live video sources, according to some embodiments of the present invention.

FIG. 9 is a flow chart of a method for registering a user in a network for multiple live video sources, according to some embodiments of the present invention.

FIG. 10A is a flow chart of a method for evaluating a stream in a network for multiple live video sources, according to some embodiments of the present invention.

FIG. 10B is a flow chart of a method for content categorization in a network for multiple live video sources, according to some embodiments of the present invention.

In these figures, like elements are assigned like reference numbers.

### DETAILED DESCRIPTION

In this detailed description, video sources and cameras are used to illustrate a system of networked environmental sensors made accessible to a community of interested users. Such sensors are not limited to those providing images and video streams, but may include thermometers, microphones, meteorological sensors, motion sensors and other suitable instruments. Data collected from such a system of networked environmental sensors may be combined with other data relevant to the interests of the community to provide new applications of business or technological significance. Some of such applications are illustrated below by the embodiments of this disclosure using video sources, such as cameras, as the environmental sensors.

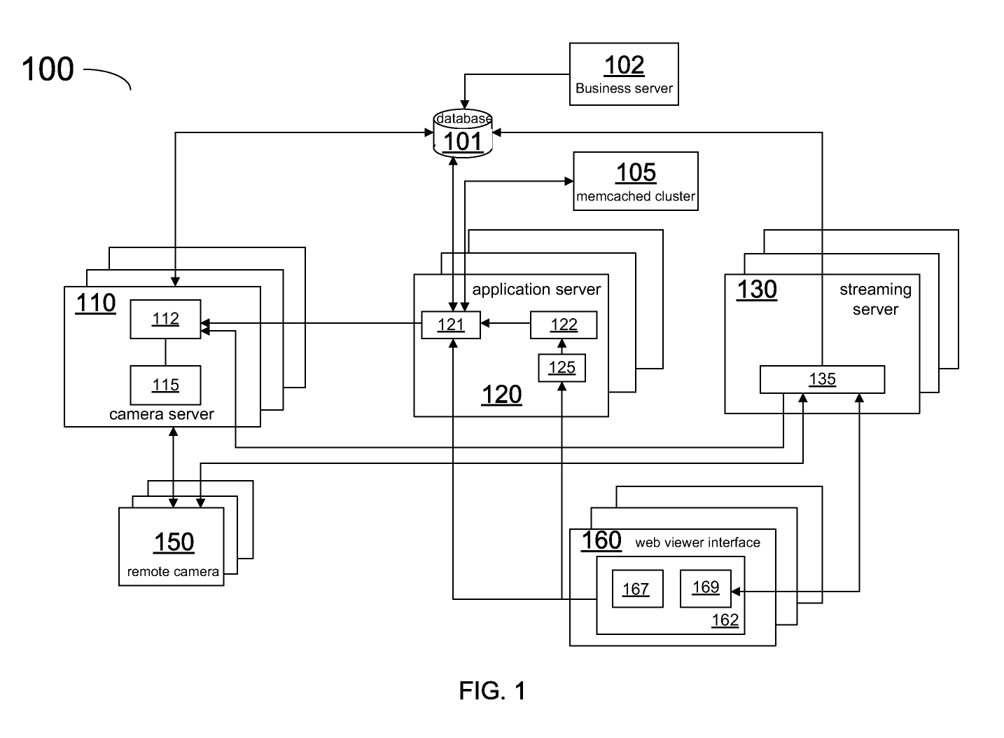

FIG. 1 illustrates system 100 which networks multiple live video sources, according to some embodiments of the present invention. System 100 includes database 101, business server 102 and mem-cached cluster 105 at a higher level in a network. Mem-cached cluster 105 is a scalable cache layer that stores data from multiple nodes in the network to reduce demand for direct access to database 101 and to provide greater responsiveness to users. With this configuration, application server 120 may more readily access desired information from mem-cached cluster 105 than from database 101. As shown in FIG. 1, the network may include multiple camera servers, web servers and streaming servers, represented in FIG. 1 by camera server 110, application server 120, and streaming server 130, respectively. Camera server 110 manages multiple remote cameras, such as remote camera 150.

Business server 102 is an event driven server which implements business rules and calculates metrics maintained in system 100, driven by updates to database 101. For example, business server 102 updates derived data in database 101 based on implemented business rules, driven by updates to database 101 from the underlying primary data are updated. In addition, business server 102 analyzes data in database 101 to compute metrics. For example, business server 102 may collect usage statistics of system activities, or correlate performance of users based on operating parameter values. In some embodiments, metrics computed by business server 102 may be reported to users for various novel business applications, some of which are set forth in examples described below.

According to some embodiments, business server 102 may control the start/stop streaming of video from remote camera 150 based upon business rules related to, for example, system performance, user privileges, or cost of delivery of the streaming video. For example, some cost considerations in business server 102 may include bandwidth usage. In some embodiments cost considerations made in business server 102 may include usage of the central processing unit (CPU) in application server 120 or any of its components such as API 121, processor 122 or processor 125.

Application server 120 interacts with users of system 100 (e.g., viewers), and uses an application program interface (API) as its interface to communicate with camera server 110, database 105, and mem-cached cluster 105. Application server 120 may include an HTML render engine and a web server. Application server 120 performs functions that are driven by commands or events flowing through the API that results in operations carried out in camera server 110 and other elements of the system. Such operations, in turn, updates the state and data in database 101 and trigger operations in business server 102, as described above.

Application server 120 may be accessed by a viewer using a web interface (e.g., web interface 160), which may include a web browser with a general purpose video player plug-in or a dedicated player “widget”, or a dedicated application program. The number of web servers that may be deployed can increase or decrease dynamically based on the number of active viewers, the number of video streams ready to become “active” (i.e., broadcasting) and the number of active video streams served to viewers. This load balancing capability results in a highly scalable system.

Streaming server 130 serves video streams, such as a video stream generated by remote camera 150. As shown in FIG. 1, the video stream may be served to a viewer at web interface 160. Streaming server 130 communicates with camera server 110, which is capable of controlling the start and stop of the video stream from remote camera 150. In some embodiments, streaming server 130 may be implemented using a Wowza media server, as known to those skilled in the art. Alternatively, streaming server 130 may be provided by content distribution networks, such as the services provided by Akamai, or Limelight, known to those skilled in the art.

Viewer web interface 160 may run on computing device 162, which may include a processor (shown in FIG. 1 as processor 167) that executes HTML code coupled to a display 169. Alternatively, web interface 160 may be configured to receive and to display video encoded using “Flash” player protocols¹. The specific code described herein to operate device 162, processor 167, or display 169 is not limiting. The examples above (e.g., HTML, Flash and HTML5) are only some embodiments among many other embodiments consistent with the present disclosure.

¹ Flash is a commercial name associated with certain products of Adobe Systems, Inc.

Camera server 110 may include a backend API 112 for access using hypertext transfer protocols (http) coupled to a small event driven server 115. API 112 performs several tasks in the backend of camera server 110, such as registration and authentication of remote camera 150. To register remote camera 150 with system 100, a potential user installs an application program into camera 150. In some embodiments, the application program may be downloaded from application server 120. In other embodiments, the application program may be obtained from “AppStores” (i.e., repositories of application programs, known to those skilled in the art). The application program is preferably capable of automatic self-updating.

Camera server 110 and application server 120 may communicate through backend API 112 and API 121 (described below). Through API 112, camera server 120 may control data streaming from remote camera 150 and other activities performed at camera 150 through instructions to the camera, such as ‘start stream’ and ‘stop stream’ through small event driven server 115. Once remote camera 150 is registered, the application provides a user interface on a graphical display of remote camera 150, informing the user that the camera may now broadcast a video stream into the network of system 100. In some embodiments, the application configures remote camera 150 to provide an RTMP video stream which can be handled by conventional media players directly or which can be easily converted by streaming server 130 to be played in other conventional media players. Camera server 110 may configure remote camera 150 to provide a video stream of a specified resolution, frame rate, i-frame interval, bandwidth and codec format (e.g., H.264).

According to some embodiments, remote camera 150 may include sensors that monitor overall health and performance of the camera. For example, remote camera 150 may include a temperature sensor, an accelerometer, and a location determination system, such as a Global Positioning System (GPS) receiver, or a WiFi or cellular telephone triangulation system. Camera server 110 accesses remote camera 150 to obtain readings from these sensors. In some embodiments remote camera 150 may be mobile. According to some embodiments, camera server 110 may include a Geo-location tracking feature for tracking the movements of remote camera 150 based on reported locations from the location determination system in remote camera 150. In such embodiments, application server 120 may provide to web interface 160 a frequently updated map showing the instantaneous locations of remote camera 150. An accelerometer may provide information (e.g., orientation relative to a vertical or horizontal axis) regarding motion of remote camera 150. This may provide a user in web interface 160 information about special events such as an earthquake, or other events of interest. Also, an accelerometer in remote camera 150 may alert application server 120 of the falling, tampering or other extraordinary movements of remote camera 150.

Geo-location information and contemporaneous timestamps may be embedded in the video stream together with a signature of the encoder, providing a mechanism for self-authentication of the video stream. A signature that is difficult to falsify (e.g., digitally signed using an identification code embedded in the hardware of the encoder) provides assurance of the trustworthiness of the geo-location information and timestamps, thereby establishing reliable time and space records for the recorded events.

Application server 120 includes API 121, processor 122, and processor 125. According to some embodiments, as mentioned above, API 121 interfaces application server 120 with camera server 110, database 101, and mem-cached cluster 105. Processor 125 may include a web server, such an Apache, interfaces with web clients. Such interactions result in operations carried out in processor 122. Processor 122, which may implement an HTML render engine, is a back end processor for application server 120. Service requests to other servers are communicated through API 121. In some embodiments, a user request to start or stop a video stream is communicated through API 121 to backend API 112 of camera server 110. API 121 also provides service for accessing database 101, preferably through mem-cache cluster 105, to perform data query and commands.

Back end processor 122 may keep statistics for remote camera health and usage using collected data or retrieved data from the sensors included in the camera. Such metrics may include server statistics, such as server state (e.g., normal operation or any of several exceptional states), number of servers in each server category, server loads (e.g., CPU or memory usage statistics, number of client connections) and uptimes. Similarly, various sensor statistics can also be collected, such as number of attached video sources and their identifiers, sensor states (e.g., active or live, ready or stand-by, reachable, suspended, disconnected). Database 101 may maintain detailed description of each sensor (e.g., name of owner, location, content category, description of content, historical records of registration and operation, responsive search keywords, current and historical statuses, current and historical operating parameters). Operational statistics may provide such information as the reliability of the video source, which may be useful, for example, for recommending the video source to potential viewers.

In general, data included in database 101 may be roughly classified into three categories: (i) automatically collected data; (ii) curated data; and (iii) derivative data. Automatically collected data include, for example, such data as reading from environmental sensors and system operating parameters, which are collected as a matter of course automatically. Curated data are data that are collected from examination of the automatically collected data or from other sources. Curated data include, for example, content-based categorization of the video streams. Video streams may be categorized based on user input or from content review. For example, at registration of the camera or at a later time, a user may provide a description of the expected content of the video stream provided by the camera. The user may also provide a descriptive name for the camera (e.g., “Golden Gate Bridge Monitor”), Content review may be provided by system administration or by viewer input. For example, system administration may have an on-going effort of reviewing sampled video streams to provide descriptive information in any suitable format that may be helpful to viewers looking to identify cameras of interest. Such description may also be provided by viewers. In some embodiments, the descriptive information may be provided as standardized classifiers, such as “traffic”, “tranquil scene”, “busy street scene”, “beach”, etc. may be used. Additional description, such as a list of descriptive keywords, may be used to allow viewers to identify the video source. As technology advances, content review can be achieved automatically or semi-automatically (i.e., with no or little human intervention). For example, detection of a significant amount of motion at speeds typical of automobiles may suggest that the content is “traffic”. Derivative data includes any data resulting from analysis of the automatically collected data, the curated data, or any combination of such data. For example, the database may maintain a ranking of video source based on viewership or a surge in viewership over recent time period. Derivative data may be generated automatically or upon demand.

In some embodiments, useful viewer statistics may be collected. For example, a periodical report on the number of viewers of a video source viewing through a widget installed in on a user-maintained page may be important to an owner of that page. The average and median durations of viewing per viewing session may also be of particular interest. To collect these statistics, each installed widget is assigned a unique identifier. Viewer preference statistics may also be compiled for identifiable viewers (e.g., registered members of system 100).

Back end processor 122 also keeps updated user profiles for both broadcasting users (e.g., the broadcast user of remote camera 150), and viewing users (e.g., the viewing user at web interface 160). In some embodiments, based on usage habits, user interests and other suitable criteria, additional profile information may be maintained. Access control or facilitation may be implemented based on collected data about the users. For example, system administration may restrict access to certain video streams or data relevant to such video streams to certain classes of users. For example, while viewing of a video stream from a public camera may be unrestricted, some curated and derivative data regarding that video stream may be made available only to registered members or to advertisers. Broadcasters may also request that access to their video streams be restricted to specific users or to a specific class of users. Advertisers may request, for example, certain user profile data regarding viewers using the widgets installed on their respect web pages. Together with content review and user profile information, business rules may be made for system administration to restrict or facilitate access to video streams and corresponding data. For example, system administration may recommend to specific users video streams of their interests based on collected data regarding their viewing habits. Such business rules may be operated by business server 102, having access to database 101.

Front end processor 125 may be a server running a front end application such as Apache for communicating with web interfaces, including web interface 160.

Streaming server 130 may include backend processor 132 and streaming processor 135 running a streaming software that transfers a video stream between a video source and one or more viewers at web interfaces simultaneously. As mentioned above, each viewer may operate a different type of playback client or device. The playback client in web interface 160 may be running video streaming applications such as Adobe Flash players, Microsoft players, and Apple players (e.g., iOS devices on iPads, iPhones, or iPods). Streaming processor 135 may also be configured to provide video streams to other types of mobile devices such as those running Android, BlackBerry OS, to IPTV set-top boxes, and to other devices that may be connected to the network. According to embodiments consistent with the present disclosure, streaming processor 135 may be configured to communicate with web interface 160 and also with remote camera 150.

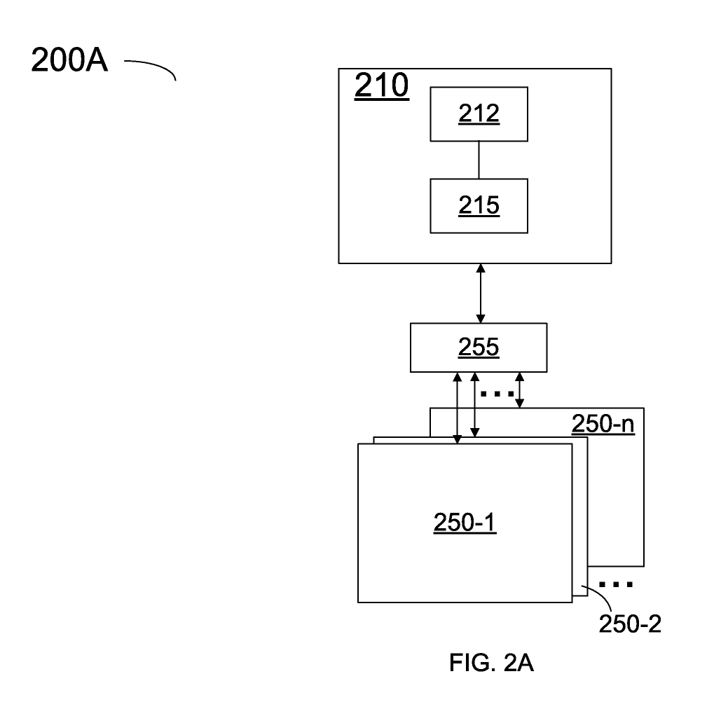

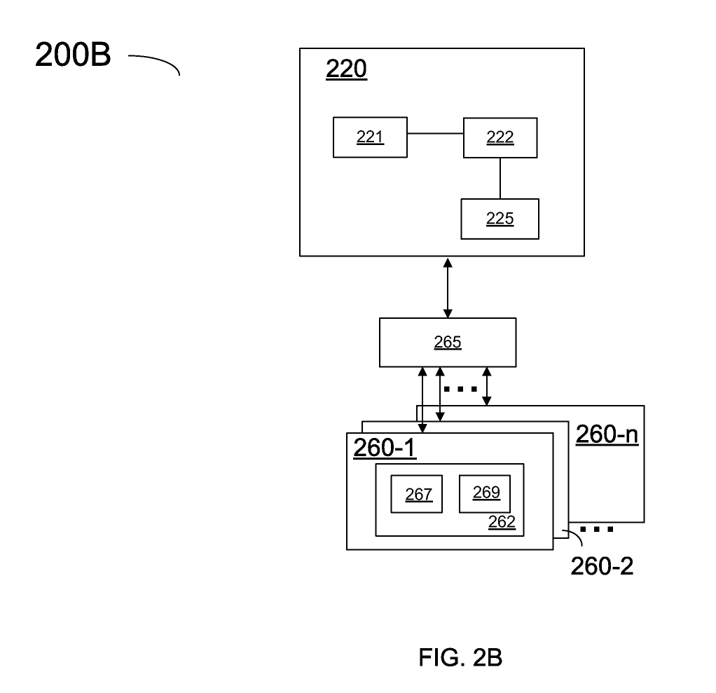

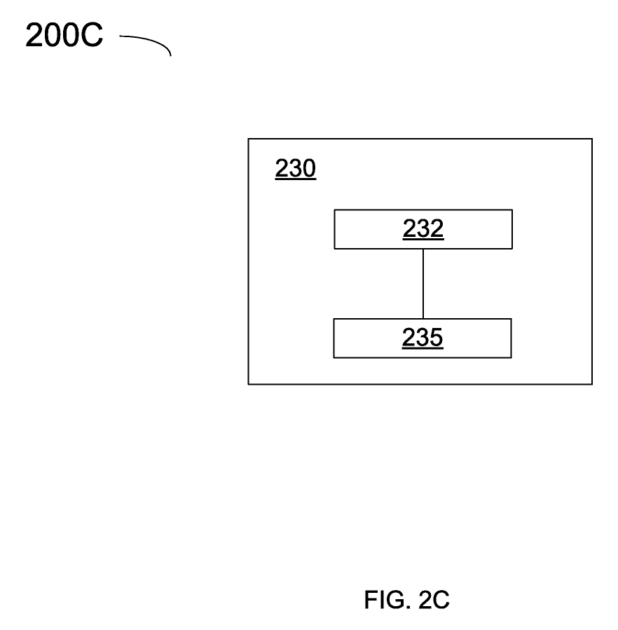

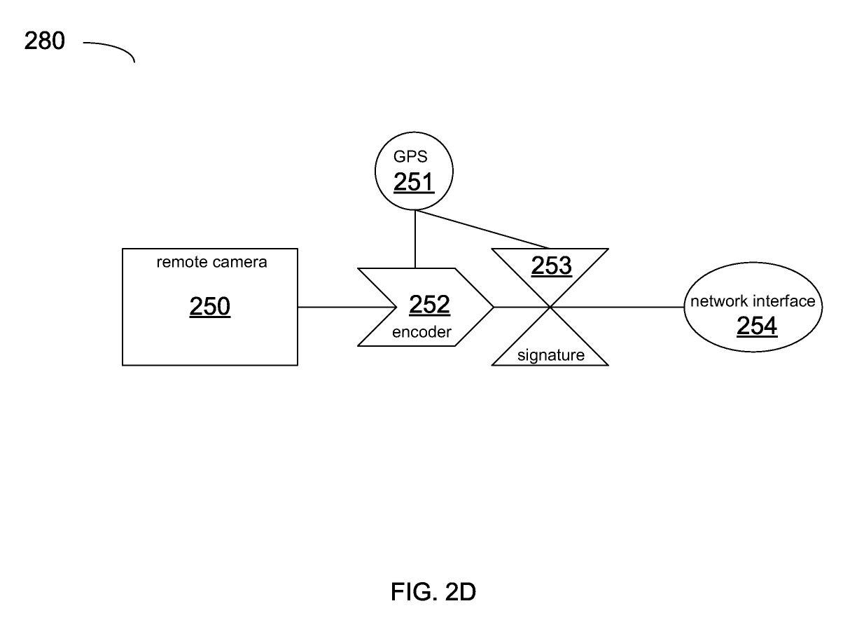

FIG. 2A illustrates view 200A of camera server 210, which communicates and controls remote cameras 250-1, 250-2, through 250-n, according to some embodiments of the present invention. Load balancer 255, such as one with conventional construction, may distribute the control and communication loads of remote cameras 250-1 to 250-n over one or more camera servers. As shown in FIG. 2A, camera server 210 includes backend API 212 and small event driven server 215, providing substantially the functions described above with respect to backend API 112 and small event server 115. These servers are small event driven servers using various suitable communication protocols. For example, server 215 may be implemented using part http and tcp-based socket message queue (MQ) protocol. Server 215 may be implemented using a secure socket layer protocol (e.g., a custom RSA protocol with block encryption).

FIG. 2B illustrates view 200B of web server 220 configured to manage a network of multiple live video sources and coupled to multiple web interfaces 260-1, 260-2, through 260-n, according to some embodiments of the present invention. Load balancer 265 may allocate an available bandwidth in a balanced manner among the data streams to and from web server 220 and each of viewer web interfaces 260-1, 260-2, through 260-n. Each of web interfaces 260-1 through 260-n may by executing on a computing device, such as computing device 262, including core processor 267 and graphical display 269. Computing device 262, core processor 267, and display 269 may be as provided in a similar manner as described above in conjunction with FIG. 1 for computing device 162, core processor 167, and display 169 respectively. Web server 220 includes API 221, backend processor 222 and front end processor 225, provided in substantially the same manner as API 121, back end processor 122, and front end processor 125, as previously described.

FIG. 2C illustrates view 200C of streaming server 230 configured to stream video data from multiple live video sources, according to some embodiments of the present invention. According to embodiments consistent with the present disclosure, streaming server 230 may include backend processor 232. Backend processor 232 is configured to perform authentication of the data stream using a token identifying a virtual connection or virtual circuit between a streaming source and the web interface. The token is used by streaming processor 235. Such a token authenticates both published and viewer data streams.

FIG. 2D illustrates tamper-proof remote camera system 280 according to some embodiments of the present invention. Camera system 280 provides authentication protocols that may be implemented by a user setting up a remote camera in camera system 280. Camera system 280 includes remote camera 250, GPS receiver 251, video encoder 252, secure signing hardware 253 and network interface 254, which communicates with a camera server (e.g., camera server 110). Secure signing hardware 253 may be provided, for example, by a circuit implementing keyed hashing for message authentication (HMAC) with an encrypted key. As mentioned above, authentication may be achieved by embedding time stamps and GPS coordinates in designated video stream frames.

According to embodiments consistent with the present disclosure, GPS coordinates from GPS receiver 251 may be embedded into data frames in a data stream output from the remote camera, together with a time stamp and a digest (hash) of selected video frames provided by remote camera 250. In some embodiments, a selected video frame may be a key frame in the video stream provided by camera 250. In some embodiments the selected video frame may appear every 100th frame in the video stream provided by camera 250. A key frame in the video stream is defined according to the video encoding protocol used by camera 250. Thus, the GPS coordinates, the time stamp and the digest of selected video frames may be signed with one or more asymmetric public key (PK) algorithm, such as Rivest-Shamir-Adleman (RSA) algorithm, Diffie-Hellman (DH) key exchange algorithm, or elliptic curve algorithm.

In some embodiments the signature for the GPS coordinates, the time stamp, and the digest of selected video frames may be executed using a device-specific message authentication code (MAC) key, kept in secure hardware. This information is then embedded in fields capable of carrying arbitrary binary information. While the specific fields depend on the encoding protocol, most encoding protocols have informational fields with an encryption capability. The encrypted fields are part of the video stream transmitted to a camera server through network interface 254.

According to embodiments consistent with the present disclosure, embedding protocols may include forward error correction information and other redundancy code, to compensate for dropped or corrupt frames. The encrypted fields embedded in the video stream may be decoded at the web interface, such as web interface 160 (cf. FIG. 1). The signatures may be verified using standard signature verification procedures. For example, a signature may be verified by creating a digest of relevant received frames performing appropriate decryption, and comparing the result with the received signature. Thus, web interface 160 establishes a strong correlation between the received video and the embedded GPS coordinates and time stamp.

In some embodiments, GPS coordinates and time stamp may also be embedded in human-readable form in the video itself. In such a configuration, the GPS coordinates and time stamp are easily observable by anyone watching the video. This can take a form of header or footer overlay containing geographic coordinates (latitude, longitude) and date/time (dd-mm-yyyy/hh:mm:ss).

In system 280 video camera 250, GPS 251, encoder 252, signature processor 253 provide an authenticated, compressed data stream to network interface 254, which transmits the compressed data stream. System 280 may be an electronic module inside a camera enclosure. In addition, each of encoder 252, signature processor 253, and network interface 254 can be made tamper-proof to any desired degree. This setup enables automated authentication of the video stream. The reliability of the authentication may depend on the level of tamper-proofing of the device. In this manner, the trust factor in the data stream may be established independently of the reputation of the device operator. Therefore, the present system broadens the class of trusted video sources that may be used for a network of multiple live video systems, including low cost cameras. Further, authentication protocols consistent with the present disclosure are independent of the camera operators and the web server managing the network. Suitable applications for authenticated data streams may range from surveillance systems, remote viewing, and event broadcasts.

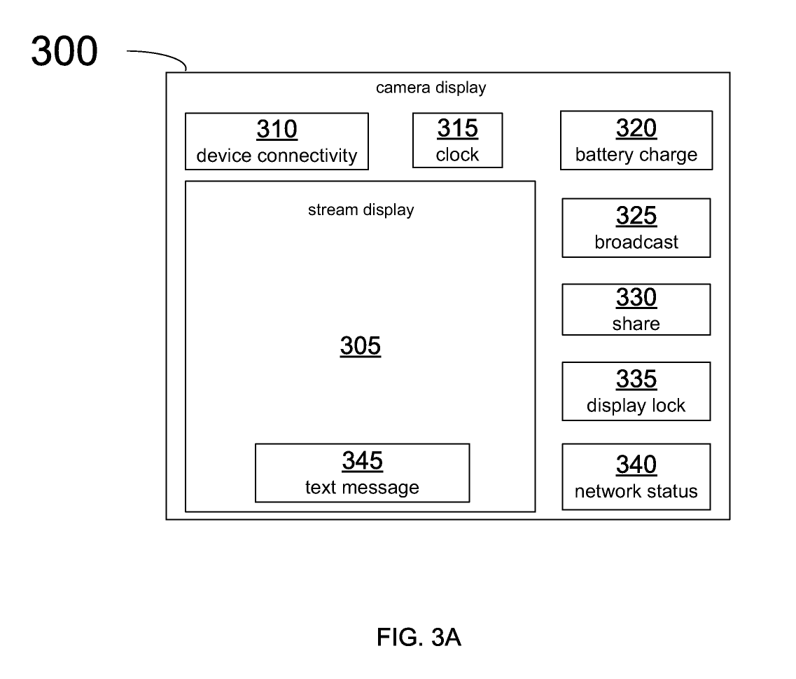

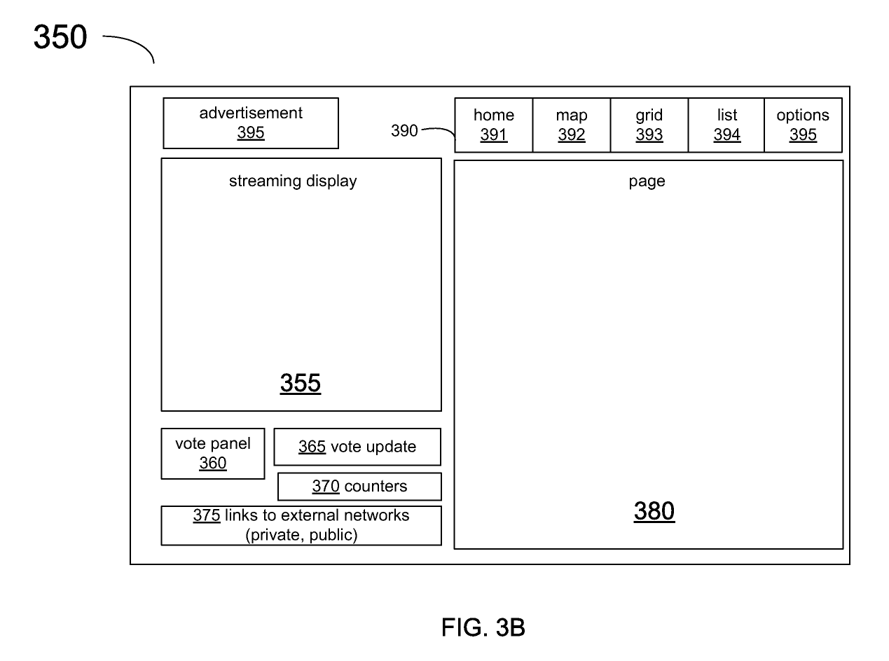

FIG. 3A illustrates display 300 of a networking application provided to a remote camera according to some embodiments of the present invention. According to embodiments disclosed herein, data and configuration information for display 300 are provided to the application program running on the remote camera using an API by a backend processor of the camera server. For example, the remote camera may be registered with system 100. And the backend API processor may be backend API 112 in camera server 110 of FIG. 1. In some embodiments, display 300 may be implemented by a touch-sensitive graphical display to allow the graphical display also to serve as an input device.

Using display 300, a user on location may be able to perform different maintenance operations to remote camera 150. Display 300 includes a stream display window 305, connectivity indicator 310, clock 315 indicating a local time, and battery charge indicator 320. Battery charge indicator 320 shows the user the amount of battery charge left in the remote camera device, if the device is operating using battery power. In some embodiments, it is desirable that the remote camera be powered by a wall power outlet during normal broadcasting, using the battery to power broadcasting operation only under emergency situations. Information displayed by indicators 305, 310, clock 315, and battery charge indicator 320 may be accessible for reading by streaming server 130 and may be embedded as metadata or any other type of data structure in the data stream. Further according to some embodiments, display 300 may include a broadcast control button 325 indicating the state of broadcast (e.g., stand-by or streaming), a share button 330 (which provides for communication with actual or institutional viewers through email or instant messaging), a lock indicator 335, a network status indicator 340, and a message textbox field 345.

According to some embodiments, broadcast control button 325 in display 300 may be selected by a user on display 300 to communicate to camera server 110 that remote camera 150 is ready to begin video streaming into the network. Similarly, broadcast control 325 may also be selected to interrupt an already streaming broadcast. For example, in some embodiments broadcast control 325 may display the message ‘Offline’ when the remote camera is not broadcasting through the network. In such a configuration, textbox field 345 may display a message prompting the user to tap on indicator 325 to enable the camera to broadcast. In some embodiments, actual broadcast does not begin after being enabled. In such embodiments, actual broadcast begins when at least one viewer accesses the video stream. Such a feature is bandwidth efficient and conserves power in remote camera 150. According to some embodiments, messages for the user in remote camera 150 may be provided by streaming processor 135 of streaming server 130. When remote camera 150 is broadcasting a video stream into the network, indicator 325 may display the message ‘On Air.’ In such configuration, textbox field 345 may display a message indicating the user that the camera is available for network viewers, and to tap on indicator 325 to disable broadcasting.

Lock indicator 335 may be used to lock display 300 or to turn it off, when no user input is expected, such as when providing live video to the network for an extended time period. In some embodiments, display 300 may be locked by a single tap on the screen. A longer tap may completely turn off display 300, without interrupting broadcasting by remote camera 150. Messages indicating each of these actions may appear in textbox field 345 to provide guidance to the user. Indicator 335 may also change color and configuration accordingly, for a simpler readout by the user.

Textbox field 345 may be used to transmit messages to the user, related to general maintenance procedures. Messages in textbox field 345 may be transmitted by streaming server 130 upon receiving device health or diagnostic information from the remote camera, such as information displayed in indicators 310, 315, and 320. For example, if the streaming server 130 detects that remote camera 150 is operating on battery power it may provide a message in textbox field 345 prompting the user to connect the camera to a wall plug. At the same time, streaming server 130 may include a message indicating an amount of time of continuous video broadcasting left within the remaining battery charge indicated on battery indicator 320. Information regarding this remaining time for broadcasting may be used by streaming server 130 and application server 120 to make network management decisions. Also, messages from streaming server 130 to remote camera 150 may include notifications to the user from application server 120. For example, such notification may regard a suspended service when an extraordinary or impermissible activity in the video stream is detected. The system also has the ability to inform the user when action is required (e.g. a remote viewer 160 wants to watch a stream that has been disabled by camera 300's owner). Real-time communication between broadcasters and viewers may occur via this channel. For example, cameras could be set up to micro-blog based upon certain environment criteria and those messages might also be shown here.

According to some embodiments, a user registering remote camera 150 (broadcaster) may have the ability to send a streaming video signal to a third party. To send the video signal, the broadcaster may send a link to the streaming video (i.e., the uniform resource locator, or “url”) to a third party via e-mail using share button 330. For example, once the broadcaster taps share button 330 the user may be prompted to fill-in an e-mail address of the intended recipient. In turn, camera server 110 forwards the e-mail address to application server 120, which sends the url in an e-mail message to the intended recipient. According to some embodiments, this feature may be provided to the broadcaster having remote camera 150, at substantially no extra cost. Other types of communication, such as instant messaging, may also be used to share the url of the video stream.

Relevant aspects of user business rules may control communication using message textbox field 345 between a broadcaster in the network and application server 120. According to some embodiments, in order to improve the networking service provided by system 100, application server 120 may be configured to provide a variety of messages to a broadcaster at remote camera 150. For example, in some embodiments, the broadcaster may be notified that the camera has been off-line or inactive for a certain period of time longer than desired or permitted by business rules.

FIG. 3B illustrates display 350 provided at a web interface of a networking application according to some embodiments of the present invention. For example, display 350 may be a browser's display of a web page served by a web-site when a user at web interface 160 selects the http address of application server 120. The user at interface 160 may be registered with application server 120 as a ‘broadcaster’, or as a ‘viewer only’ user. (A broadcaster is one who has a remote camera accessible by the web server via a camera server). The camera server may be, for example, camera server 110 of FIG. 1. Thus, display 350 allows a user to access a remote camera using a web interface. In embodiments consistent with the present disclosure, display 350 allows interactive features between a web browser and a web server (e.g., application server 120 of FIG. 1)

Alternatively, a ‘viewer only’ user does not have a remote camera associated with the user account. That user may nevertheless still view streaming videos from any remote camera in the network. Certain viewing privileges may be provided exclusively to broadcaster users, in order to incentivize a viewer-only user to become a broadcaster. For example, a broadcaster may be able to send a link to his broadcast video stream to any third party in the manner previously described. The third party need not be a registered user of the current network of multiple online video streaming sources.

As shown in FIG. 3B, display 350 includes a field 355 for display of a video stream. Field 355 receives a video stream from a stream server, such as stream server 130 of FIG. 1. Server 130 may provide video streams encoded for a Flash player in web interface 160. In some embodiments, web server 130 may provide a video stream encoded for a universal player, so that any video format may be processed for display on display field 355. According to some embodiments, when a user registers to the network through an application server (e.g., application server 120), the application server may install in the web interface device a suitable player for display field 355.

According to embodiments consistent with the present disclosure, display 350 may include vote panel 360, vote update field 365, counter and metrics field 370, and links field 375. Vote panel 360 may include an option for the user to cast a vote representing approval or disapproval of the content in a video stream displayed on streaming display field 355. Thus, vote panel 360 provides a way to perform camera ranking, which may be used to select a given video stream for use in a virtual stream. A virtual stream is a derivative stream that combines one or more actual streams which may be live or pre-recorded. A virtual stream may be used, for example, for advertising purposes, in lieu of a real stream because of its ability to integrate multiple data sources into a single compilation which creates convenience and value for the end user. Field 365 may include an updated vote count for the remote camera stream displayed on streaming display field 355. In addition, a “Flag” button may be provided as an immediate way for any member of the community to indicate that a given video stream does not meet the community's standards (or it violates some society norms or laws). Similarly, a “Favorites” button provides a way for the user to indicate that a given video stream is desirable such that it should be saved in a “quick list” of select cameras for later viewing.

Counter and metrics field 370 may include an updated count of viewers and citations made to the remote camera stream displayed on streaming display field 355. Links field 375 may include links to an external network to which the user may subscribe. By tapping on links field 375, the user may submit a video stream displayed on streaming display field 355 through the external network. The user may also submit a single screen shot of the video stream displayed on streaming display field 355 through links field 375 to the external network. The ability for a user to have access to links field 375 may depend on the type of account the user has with the application server. For example, a broadcaster registered with the application server may have privileges extending to the use of links field 375, allowing the user to send screen shots and video screens to the external network, either private or public.

Further according to some embodiments, display 350 may include page field 380, and menu field 390. Page field 380 displays items selected by the user from menu field 390. Menu field 390 may include different selections, such as home 391, map 392, grid 393, list 394, and other options 395. Page field 380 may include stream metrics provided by the web server to display 350 for a selected group of remote cameras, according to the selection in menu field 390. These selections will be described in more detail, below.

According to some embodiments, home field 391 may include a dashboard, or links to ‘My Cameras,’ ‘My Favorites,’ ‘My Alerts.’ A dashboard may split the entire display 350 into a portion showing ‘My Cameras’ section, a portion showing ‘My Favorites’ section, and a portion showing ‘My Alerts’ section. This section may also provide controls to manage the camera. For example, camera owners may control access to private cameras or perhaps control settings of the camera (e.g., exposure and/or focal length).

The ‘My Cameras’ section, when selected from the dashboard, displays screen shots of the remote cameras registered by the user to be broadcasting. In some embodiments, the web server may provide statistical data to the user about the remote cameras selected in the ‘My Cameras’ section. For example, for each of the cameras in that section, the web server may display a graph showing the number of views over time of a particular video stream. Further, the web server may provide in the ‘My Cameras’ section the number of viewers currently accessing the video stream for each camera. Also included in the ‘My Cameras’ section is the total number of viewers that have accessed the video stream and the total number of minutes of video streamed through the network for any given remote camera. Additionally, ‘My Cameras’ is likely to also permit the setting of automated triggers (alerts) that can be sent to the owner or other users.

The ‘My Favorites’ section, when selected from the dashboard, displays screen shots of remote cameras in the network that have been selected by the user as ‘Favorites’. For example, the ‘My Favorites’ section may include cameras that are registered to the user as a broadcaster, and also cameras registered by other broadcasters that the user selects as a viewer. The ‘My Alerts’ section includes messages, alerts, comments, and annotations provided by other users in the network. The messages, alerts, comments, and annotations may be related to specific remote cameras in the system, or to general topics of interest for the network users. Also, the user may log-in a message, alert, comment or annotation to be provided to other network users, from the ‘My Alerts’ section.

Map field 392 may include a map showing locations of remote cameras within the network, displayed in page field 380. The map may include camera icons provided at precise geo-locations of each of the remote cameras in the network, showing a street layout or a layout of relevant geographical landmarks. For example, some embodiments may include a map—such as a geo map—provided by a third party networking service. When a camera icon is selected on the map, stream server 130 may provide live video feed from the corresponding selected camera on stream display field 355. Grid field 393 may open a grid or matrix of screen shots of remote cameras in the network, in page 380. Thus, a user logging into display 350 may tap on any of the images in grid field 393 to open a live video stream on streaming display field 355. List field 394 may display on page field 380 a list of remote cameras in the network, with each remote camera associated with a thumbnail image that represents a screen shot from the corresponding camera, placed next to a name assigned to that camera. Such a name may be provided by a broadcaster upon registration of the camera with the network, and may include a few descriptive words for naming the camera. Options field 395 may display on page field 380 detailed information of the user account with the network, such as account type (e.g. ‘broadcaster’ or ‘viewer only’).

In some embodiments, display 350 may also include advertisement field 395. Advertisement field 395 may be filled by the application server (such as application server 120) with content relevant to the video stream being played in streaming display field 355. To provide relevant content, the application server accesses database 101 for the content description and content category information. Alternatively, the application server may parse the data contained in the video stream provided by the stream server. Thus, content oriented advertisement may monetize relevant content, or provide a convenient shopping opportunity for the viewer. In some embodiments, data mining may be performed in the application server from data associated with the video stream handled by the streaming server and also other user information (e.g., the http address of web viewer interface 160). For example, the application server may be able to link the content in the video stream with information about the user accessing the stream. Information about the user may be, for example, geographical location, age, gender, time of day of active viewing, and other relevant information. Data mining may also be performed based on the content in the video stream and information about the remote camera providing the video stream. For example, the content of the video stream may be searched to identify car models appearing in the video, which may indicate an affluent or blighted neighborhood. The reported geo-location of the remote camera may also be similarly used. Other information that can be extracted from the remote camera may be, for example, time of day, level of lighting in the ambient, and state of motion (stationary, constant speed, acceleration) of the subject captured by remote camera 150.

Further, according to some embodiments, display 350 may provide additional interactions between the viewer of display 350 and the remote camera providing the video stream of display field 355. A web server may also provide buttons and controls in display 350 selectable by a viewer to manipulate the remote camera. Such manipulations may include, for example, zooming, panning, or directing the camera to focus on a specific location. Also, the buttons and controls may allow a viewer to control the scenery shown in the video stream. To allow user control of a remote camera, user addressable hardware may be required in the remote camera. A user-selected action from display 350 is transmitted through the application server to the camera server, which would send the relevant instructions to be executed in the remote camera to achieve the desired actions.

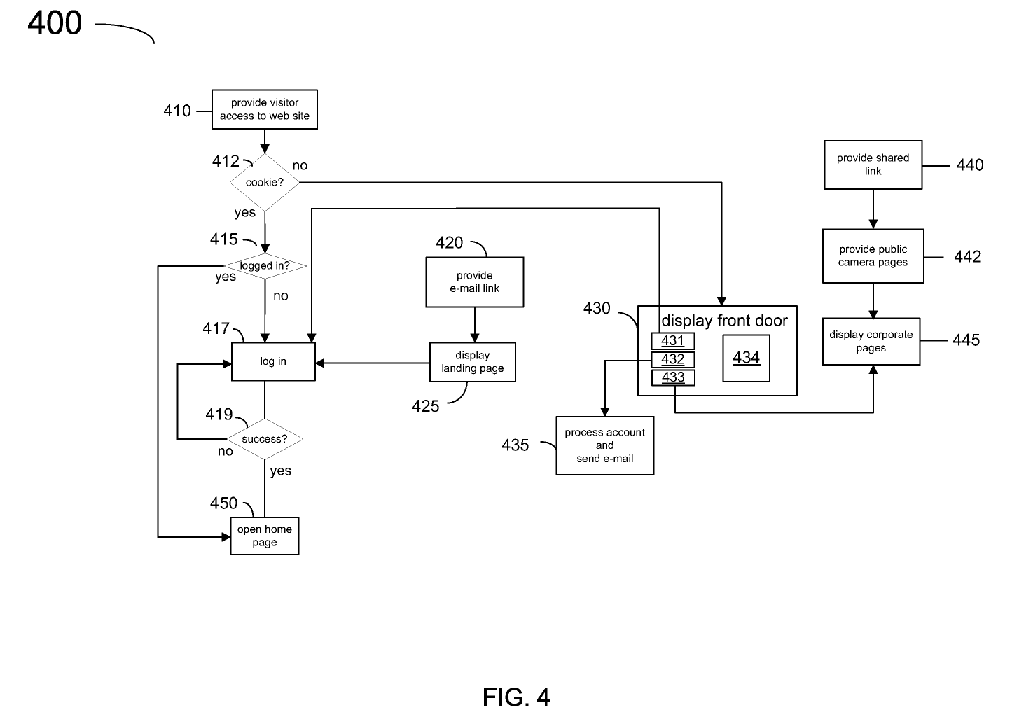

FIG. 4 is a flow chart of a method 400 for operating a server configured to manage a network of multiple live video sources, according to some embodiments of the present invention. According to embodiments disclosed herein, method 400 may be performed by an application server such as application server 120 of FIG. 1. At step 410, the application server configures for a web visitor a web page showing the network of multiple online video streaming sources, to be displayed by the visitor's web interface (e.g., web interface 160 of. FIG. 1). At step 412, the application server verifies whether or not the visitor's web interface includes current state information, e.g., such as that contained in a ‘cookie,’ so as to provide the visitor a quick and direct access to the network. When the application server detects no ‘cookie,’ the application server serves at step 430 the web page that represents a front door to the system website.

According to some embodiments, displaying a front door in step 430 includes displaying login button 431, new customer form 432, footer links 433, and video field 434. Login button 431 allows a registered visitor to log into the network in step 417. When a new user fills in new customer form 432, the application server processes the information to establish an account for the new user and informs the new user in an e-mail message at step 435. In some embodiments, the e-mail message to the new user is part of an authentication mechanism to ensure the validity of the user request. A virtual video stream may be displayed in video field 434, or a thumbnail may be displayed selected from a remote camera in the network. In other embodiments, a picture of selected content may be displayed. When the user taps on the footer links in step 433, the application server serves corporate pages at step 445. Corporate pages may be external pages covering standard corporate information, such as ‘about us,’ ‘legal,’ ‘careers,’ ‘support,’ and ‘contact’. An external page is a page that is generally available, as opposed to an internal page that is available only to registered users that have completed the login procedure for the current session.

In some embodiments consistent with the present disclosure, a application server may provide at step 440 a shared link which allows a visitor to access a specific video source, regardless of the visitor's registration status. An existing user registered with the network may decide to provide a shared link to a friend who is not a registered user through the application server. When the visitor selects the shared link provided at step 440, the application server grants the visitor access to the designated camera at step 442 by serving public camera pages. Public camera pages are pages featuring feeds from remote cameras registered within the network that can be served to the general public. In some embodiments, a remote camera registered with the network may be listed as ‘public.’ Such a remote camera may be served to an un-registered user. In this manner, a registered user say a restaurant owner, may provide a potential customer to his restaurant website a link to a public camera registered to the network, so as to allow the user a current live video stream featuring his restaurant. The link may be embedded in a media player widget included in a web-page. Such a widget, as mentioned above, may be tracked to collect viewing statistics, and for advertising accounting purposes. This application is useful to many businesses, such as a retail store. To provide such access, an application server (e.g., application server 120) may provide a link to the video stream of the remote camera embedded in a user web page that is served to the visitor. According to some embodiments, application server 120 may also provide the link to the streaming video through streaming server, such as streaming server 130 of. FIG. 1.

In some embodiments, ‘private’ remote cameras are provided in the network. A ‘private’ camera in the network may be configured such that only pre-approved registered users of the network may access the video stream of the private camera. Such private cameras may be used, for example, in surveillance applications.

An application server performing method 400 may verify that the user has logged in at step 415. If the user has not logged in, then a log-in prompt is provided by the application server in step 417. When the application server determines a successful log-in in step 419 or in step 415, the application server serves the network home page at step 450. A network home page so served at step 450 may be displayed on display 350, in the manner already described with respect to FIG. 3B.

Further, according to embodiments consistent with the present disclosure, an application server performing method 400 may provide an “email” link to a user or visitor at step 420 to ask for an email address from the user or visitor. When a user or a visitor selects the e-mail link, the application server serves a landing page at step 425. Using a form on the landing page, the application server parses the visitor's specified e-mail address to verify that a lexically acceptable email address is provided and creates a user or visitor profile. After the application server has created a user profile, it then serves a log-in prompt page for the visitor at step 417.

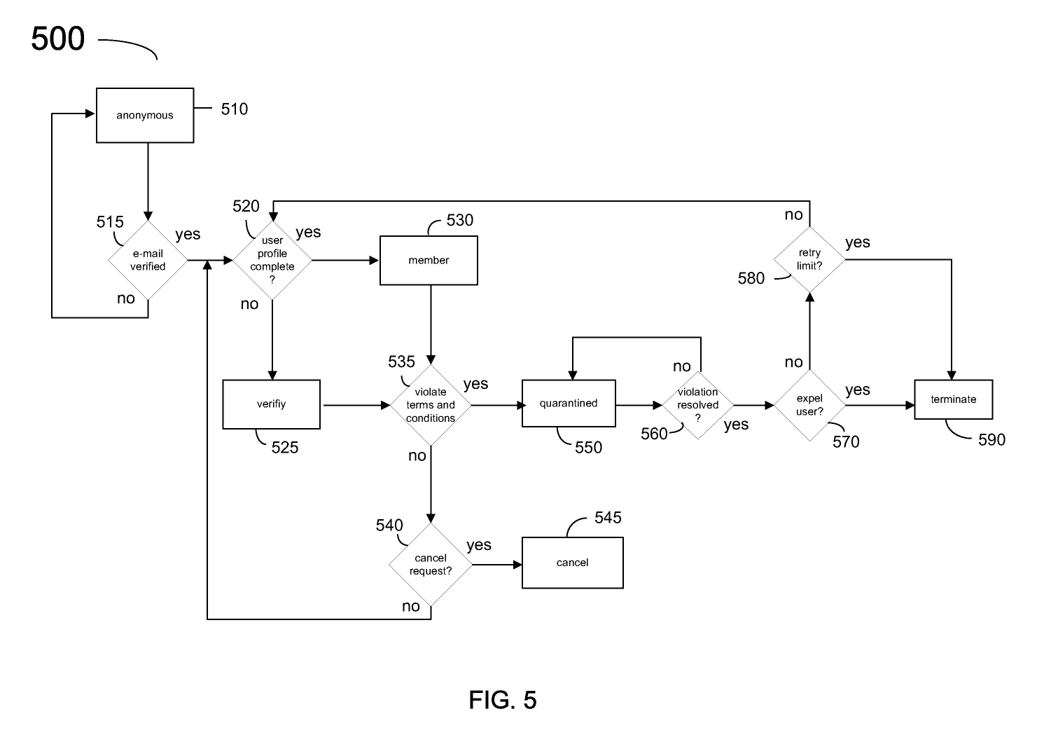

FIG. 5 is a flow chart of a method 500 for managing users in a network for multiple live video sources, according to some embodiments of the present invention. Method 500 may be performed by an application server such as application server 120 of FIG. 1. According to some embodiments, application server 120 is configured to communicate with camera server 110 and with streaming server 130 of FIG. 1. Furthermore, the application server performing method 500 may be configured to communicate with a display in a web interface, such as web interface 160. Application server 120 may perform the steps in method 500 using internet protocols such as HTML and HTML5, executed in one or more processors such as processors 122 and 125 of application server 120.

At step 510 an anonymous user is detected. Anonymous user is either a first time user of the network who has yet to register, or a user that has provided an e-mail address, but otherwise has not completed the registration process. According to some embodiments, at step 515, application server 120 may send an e-mail to the e-mail address provided by the anonymous user, encouraging the user to provide information to complete the registration process. The user registration may be completed using an email response in step 515. A complete user profile is determined in step 520 when the user respond to a registration e-mail message sent in step 515. The registered user is assigned the status of member at step 530. If the user's e-mail response is not verified the application server returns to step 510 of method 500. The user does not gain access to the network until the registration status is changed. If the user profile has not been completed in step 520, an e-mail request for verification is performed in step 525. The registered user is checked for any violation of the terms and conditions (T&C) of the network at step 535. If no violation is detected, then step 540 queries if the user desires a cancellation of his registration. If no cancellation is desired, then step 520 is repeated until the user profile is complete. Otherwise, the user account is cancelled at step 545. If a violation of the terms and conditions is detected at step 535, the user is quarantined (i.e., denied access at step 550 until the violation is resolved at step 560. When the violation is resolved, at step 570 method 500 determines whether or not to expel the user from the network. If user is not expelled as a result of executing step 570, method 500 determines at step 580 whether the retry limit has been reached. If the retry limit has not been reached, step 520 is repeated to verify if the user's profile is complete. If the retry limit has been reached, the user is terminated at step 590. The retry limit may be a maximum number of times that a given user may be quarantined before the user is expelled and terminated from the network. If a decision to expel the user is made at step 570, the user is terminated in 590.

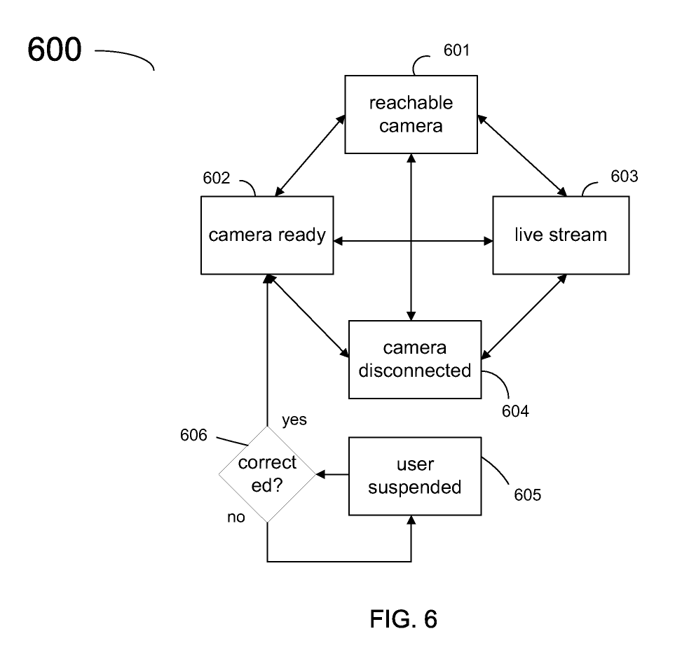

FIG. 6 is a flow chart of a method 600 for verifying a client status in a network for multiple live video sources, according to some embodiments of the present invention. Method 600 may be performed by an application server such as application server 120 of FIG. 1. According to some embodiments, application server 120 is configured to communicate with camera server 110 and with streaming server 130 of FIG. 1. Furthermore, an application server performing method 600 may be configured to communicate with a camera (e.g., remote camera 150) through camera server 110. Application server 120 may perform the steps in method 600 by using internet protocols such as HTML and HTML5, running on processors such as processors 122 and 125. According to some embodiments, application server 120 may perform the steps of method 600 by providing commands and receiving data from camera server 110.

At step 601, a reachable camera status is determined, indicating whether or not a remote camera is capable of communicating with the application server. At step 602, method 600 determines if the remote camera is in a ready status. In the ready status, the remote camera is ready to start broadcast into the network upon receiving an instruction to do so from the camera server (e.g., camera server 210). According to some embodiments, a camera ready status at step 602 may also include a temporary state in which no viewer request to watch the contents of the camera is detected. The camera does not proceed to live stream status unless at least one request for viewing is received. In step 603, a live stream for a remote camera may be enabled from the camera ready status or reachable camera status. According to embodiments consistent with the present disclosure, the application server sets broadcast indicator 380 of a viewer's display (e.g., display 300 of FIG. 3) to the “On Air” state for a remote camera in the live stream status. Step 604 detects a disconnected camera, i.e., a remote camera that is not in the reachable status, camera ready status, or live stream status. According to some embodiments, a disconnected status detected at step 604 may result from a powered ‘off’ camera, from a connectivity problem in the network, or all other error conditions.

In addition, application server 120 detects at step 605 whether or not a remote camera is suspended. If the remote camera is suspended, the application server blocks the camera from broadcasting a video feed, or from sending thumbnails images (or e-mail messages) to other network users. A remote camera may be suspended from the network for violating any business rule or protocols established by the network. For example, in some circumstances a remote camera may be suspended when the content of the video stream is offensive or otherwise inappropriate. In some circumstances, a remote camera may be suspended from the network when the video stream is of no current interest. According to some embodiments, it may be desirable for camera server 110 to transmit, or for application server 120 to retrieve thumbnail images or video from the camera to application server 120 for inspection by authorized personnel to review. Such thumbnail images may not be available to other users or subscribers of the network. Authorized personnel in the network may determine at step 606 that the video stream from the suspended remote camera has been corrected. At step 606, the application server may allow a suspended remote camera to return to ‘camera ready’ status of step 602.

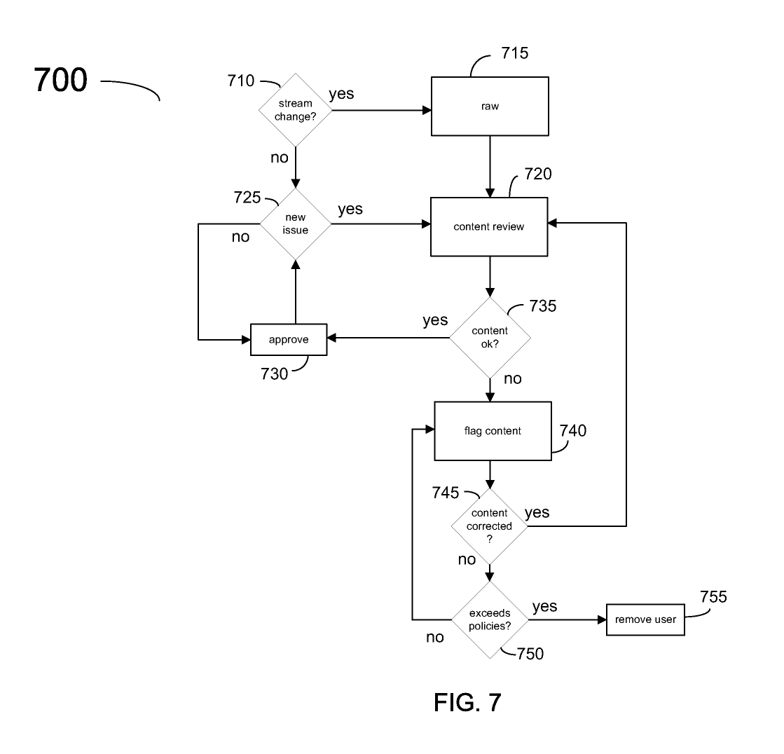

FIG. 7 is a flow chart of a method 700 for verifying a stream status in a network for multiple live video sources, according to some embodiments of the present invention. Method 700 may be performed by an application server such as application server 120 of FIG. 1. According to some embodiments, application server 120 is configured to communicate with camera server 110 and with streaming server 130 of FIG. 1. Furthermore, an application server performing method 700 may be configured to communicate with a remote camera such as remote camera 150 through camera server 110. Application server 120 may perform the steps in method 700 by internet protocols such as HTML and HTML5, running on processors such as processors 122 and 125 of application server 120. According to some embodiments, application server 120 may perform the steps in method 700 by providing commands and receiving data from camera server 110.

At step 710, it is verified whether the content in a video stream from the remote camera has changed. If a change of content is detected in step 710, the raw new video stream is sampled and captured at step 715 and sent for content review at step 720. If the content is determined to satisfy network requirements, the remote camera is approved in step 730. In step 725, even when the content is determined at step 710 to have not changed, a further verification may be made to determine if a new issue has arisen with the content broadcast from the remote camera. If no new issue is identified, the remote camera is approved at step 730. Thus, according to some embodiments, after step 730 is completed, the remote camera may be set in a ‘camera ready’ state (or any of “reachable,” “live,” or even “disconnected” state, as appropriate). The content remains approved until an event is detected giving a reason to believe that the content requires another review.

However, if it is determined at step 735 that the new content does not satisfy the network requirements, at step 740, the stream content is flagged. At step 745, it is verified whether or not the content of the video stream has been corrected to now satisfy network requirements. If so, method 700 is repeated from step 720 for content review. Otherwise, i.e., If the stream content has not been corrected, at step 750, it is determined whether or not the stream content violates certain network policies. If so, the user associated with the remote camera is suspended at step 755, and the remote camera is placed in a ‘suspended’ status (see, e.g., step 605 in FIG. 6). If the network policies are not determined to have been violated in step 750, method 700 is repeated from step 740 until corrective action of user suspension are determined in either step 745 or step 750.

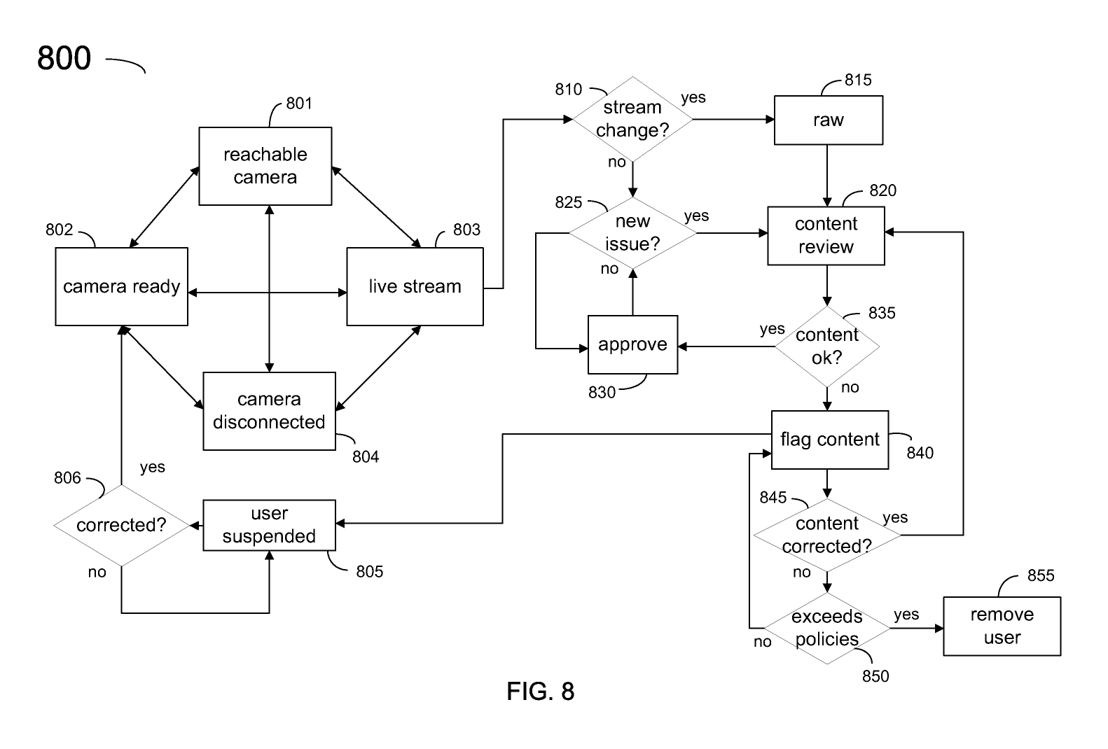

FIG. 8 is a flow chart of a method 800 for performing client and stream interactions in a network for multiple live video sources, according to some embodiments of the present invention. Method 800 may be performed by an application server such as application server 120 of FIG. 1. According to some embodiments, application server 120 is configured to communicate with camera server 110 and with streaming server 130 of. FIG. 1. Furthermore, an application server performing method 800 may be configured to communicate with a remote camera such as remote camera 150 through camera server 110. Application server 120 may perform the steps in method 800 by using internet protocols such as HTML and HTML5, running on processors such as processors 122 and 125. According to some embodiments, application server 120 may perform the steps in method 800 by providing commands and receiving data from camera server 110.

According to embodiments consistent with the present disclosure, method 800 combines the steps of method 600 for verifying a client status and method 700 for verifying a stream status, described in detail above with reference to FIGS. 6 and 7, respectively. Thus steps 801 through 806 in method 800 correspond to steps 601 through 606 of method 600, respectively, and steps 810, 815, 820, 825, 830, 835, 840, 845, 850, and 855 in method 800 correspond steps 710, 715, 720, 725, 730, 735, 740, 745, 750, and 755 of method 700, respectively. In some embodiments, when the content of a video stream is flagged at step 840, the user associated with the remote camera that generates the suspended stream is suspended at step 805. When step 845 determines that the content of the video stream has been corrected, the information is used at step 806 to set the remote camera back in ‘camera ready’ state. When step 845 determines that the stream has not been corrected, the user remains suspended in step 805, while step 850 determines whether or not the content of the video stream violates certain network policies.

Further according to some embodiments, when step 803 determines that the remote camera is providing a live stream, step 810 verifies whether or not the content in the video stream has changed, so that further verification of the stream status is required. Thus, steps 810, 820, 825, 830, 835, 840, 845, 850, and 855 of method 800 may follow, as steps 710, 720, 725, 730, 735, 740, 745, 750, and 755 of method 700, in the manner described in conjunction with FIG. 7 above.

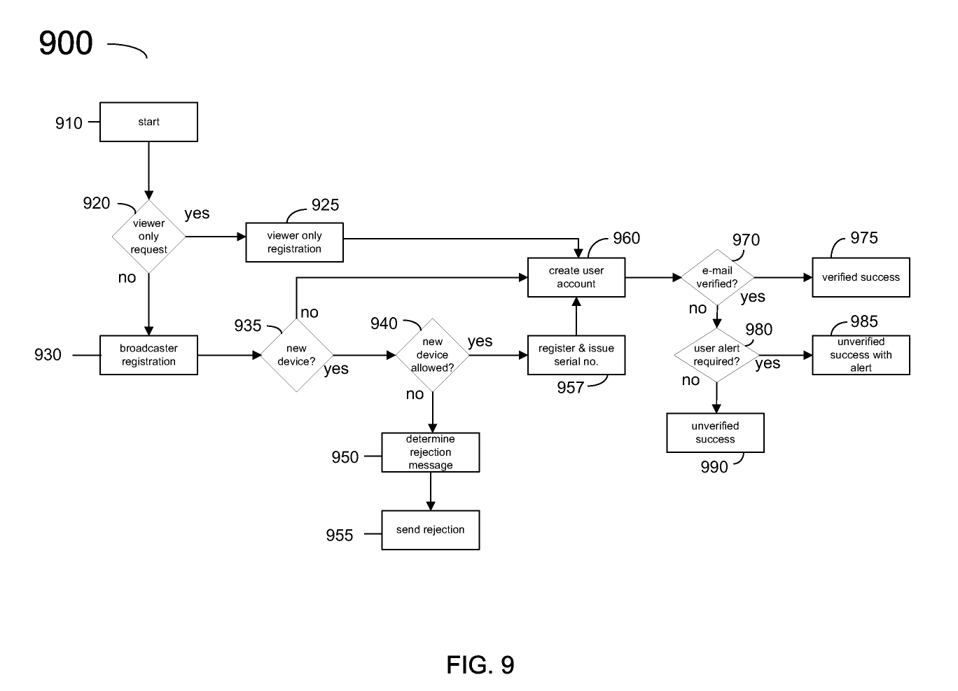

FIG. 9 is a flow chart of a method 900 for registering a user in a network for multiple live video sources, according to some embodiments of the present invention. Method 900 may be performed by an application server such as application server 120 of FIG. 1. The application server may communicate with a web interface to a viewer (e.g., web interface 160), so that the viewer may be able to register as a user of the network. At step 910, registration is started when the user selects a registration button provided by the application server in a web page served. At step 920, method 900 determines if the registration is a broadcaster request (e.g., via a remote camera) or a request from a web visitor. When the user declares a ‘view-only’ registration at step 925, a user account is created at step 960. When the user declares a broadcast user registration at step 930, the user is queried for registration of a new device at step 935. According to embodiments consistent with the present disclosure, a device may be a remote camera such as camera 150 of FIG. 1, configured to communicate with a camera server, such as camera server 110 of FIG. 1. The user may already have a previously registered device, and may desire to add a new one. If the device is already known by the application server, then the application server proceeds to create a user account in step 960. If the device that the user desires to register in the network is a new device, at step 940, method 900 determines whether or not the new device is allowable. When the new device is determined to be allowable, the device is registered and a device identification or serial number for the device is issued at step 957. At step 957, the device identification is entered into the network database (e.g., database 101 of FIG. 1). Alternatively, if the new device is determined not to be allowable, an error message appropriate to the rejection is generated at step 950 to be displayed to the user.

At step 955, the rejection message is sent to the user application. In some embodiments, the rejection message may appear in a textbox such as textbox 345 in display 300 of FIG. 3. When the user account is created, at step 970, the user e-mail address is verified. At step 975, a successful verification of the user e-mail address is confirmed. If however, the user e-mail verification fails at step 970, step 980 determines if a user alert is required. If so, step 985 completes the registration as unverified, but includes a user alert. In this state, the application server may send an ‘unverified success’ message to the user application, triggering a special alert to the user. The message may contain text indicating a special alert or reminder for the user to provide a properly verifiable e-mail address to complete the registration procedure. The message may further contain triggers in the application itself, so that text messages appear periodically in textbox 345 of display 300 to remind the user to perform e-mail verification or correction. When step 980 determines that a user alert is not required, step 990 completes the registration process as unverified, without a user alert. In this state, the application server may send an ‘unverified success’ message to the user application. The message may appear in textbox 345 of display 300.

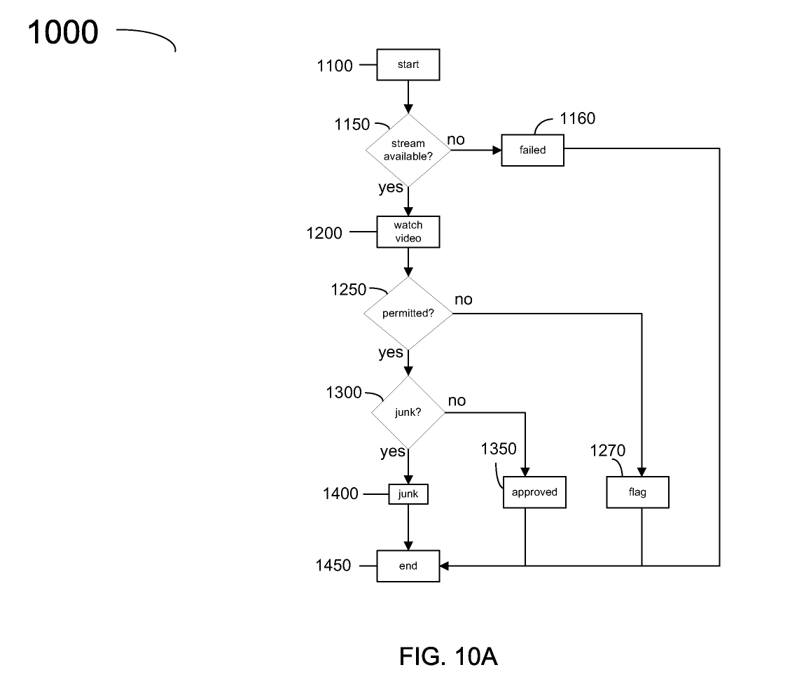

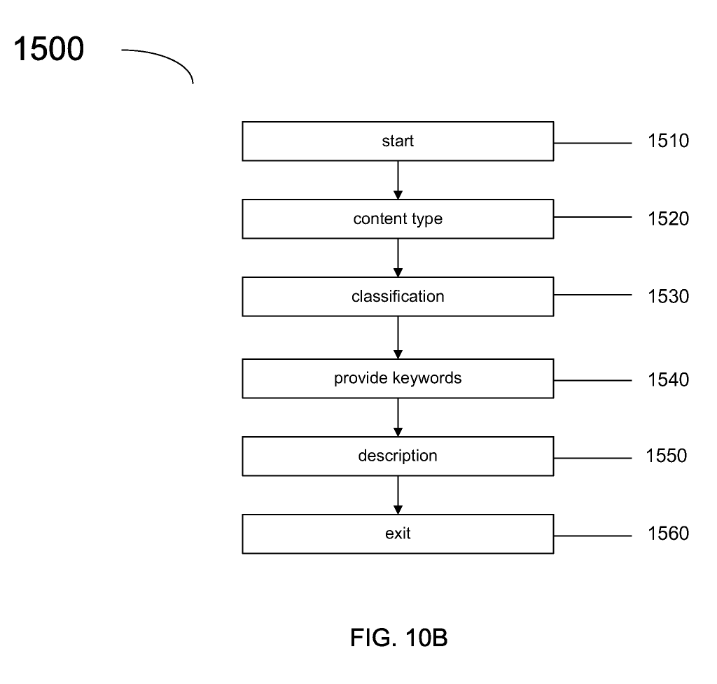

FIG. 10A is a flow chart of a method 1000 for evaluating content in a stream in a network for multiple live video sources, according to some embodiments of the present invention. Method 1000 may be performed by a application server such as application server 120 of FIG. 1. According to some embodiments, application server 120 may provide to an external unit the video stream produced by a remote camera communicating with a camera server. Method 1000 ensures content moderation and control of the video stream. Further according to some embodiments, method 1000 may be performed by a person monitoring the contents of video streams managed by the application server in the network. At step 1100, method 1000 begins either by authorized personnel managing the application server, or automatically after a specified time period of broadcast. At step 1150, method 1000 detects if a video stream is being broadcast from the remote camera. According to some embodiments, the video stream is provided by a camera server coupled to the remote camera. When a broadcast stream is not detected, the remote camera is marked as failed and method 1000 is terminated (step 1450).

When a broadcast video stream is detected at step 1150, the video stream is watched for a specified time period at step 1200. At step 1250, method 100 determines whether or not the content of the video stream is permissible. According to some embodiments, a video stream that contains illegal activities, that jeopardizes public safety, violates copyright laws, or contains certain kinds of nudity may not be permitted. At step 1270, the video stream is flagged if the video content is determined to be impermissible at step 1250. At step 1300, method 1000 evaluates if the content of the video stream is of no interest (“junk”). For example, an irrelevant, inconsequent, or uninteresting video stream may be classified as ‘junk.’ According to some embodiments, a video stream is considered of no interest, if the camera is pointing to an empty wall, or to a dark room. At step 1350, the video stream is approved if the content is determined not to be ‘junk,’ at step 1300. At step 1400, the video stream is determined to be ‘junk’. The content review ends in step 1450, having determined the video stream to be one of ‘approved,’ ‘flagged,’ or ‘junk.’

FIG. 10B is a flow chart of a method 1500 for content categorization in a network for multiple live video sources, according to some embodiments of the present invention. As shown in FIG. 10B, method 1500 starts at step 1510. Thereafter, a content type is determined at step 1520. According to some embodiments, the content type of the video stream may be ‘interior’, ‘exterior’, or ‘indeterminate’. The content of the video stream is further classified at step 1530. Some embodiments may use the following categories at step 1530: ‘Animals’, ‘Business’, ‘Construction’, ‘Dining’, ‘Landmarks’, ‘Nature’, ‘People’, ‘Shopping’, ‘Traffic’, and ‘Other’. Keywords are associated with the content at step 1540. Such keywords may describe succinctly certain elements of the video stream. The keywords corresponding to the classification are associated at step 1540. A description of the video content is the provided at steps 1550. In some embodiments the description includes a title and a descriptive text. In some embodiments the title may not include more than a certain number of words (e.g., three (3)). Further, the description may not include more than a certain number of words, for example one hundred (100). The categorization method is exited and terminated in 1560.

Embodiments of the invention described above are exemplary only. One skilled in the art may recognize various alternative embodiments from those specifically disclosed. Those alternative embodiments are also intended to be within the scope of this disclosure. As such, the invention is limited only by the following claims.

What is claimed is:

1. A system providing a network of multiple live video sources, comprising:
a device server having a control interface that exchanges control signals with each of one or more of the video sources, each video source providing a video stream in accordance with control data received at the device server;
an application server that allows controlled access of the network by qualified web clients and providing the control data to the device server in response to data input received from the web clients;
a streaming server which, under direction of the application server, routes the video streams from the one or more video sources to the qualified web clients; and
a database system for system data accessible by the application server in conjunction with providing service to the web clients.

2. A system as in claim 1 further including a business server that provides the control data to the application server based upon system performance information.

3. A system as in claim 1, further comprising a cache system for the database system.

4. A system as in claim 1, wherein the system data comprises one or more of the following categories: (a) data collected automatically from sensors related to the video sources; (b) data collected from external input or from content review of the video sources; and (c) data resulting from analysis of data in categories (a) and (b).

5. A system as in claim 4, the system data comprises a categorization of the video sources based on content review.

6. A system as in claim 4, wherein the system data further comprises user profile data.

7. A system as in claim 5, wherein the user profile data includes data collected on users based on their usage of the system.

8. A system as in claim 6, wherein the system implements access control and facilitation to video sources and associated system data based at least in part on the user profile data and a categorization of the video sources based on content review.

9. A system as in claim 1, wherein the control data comprises an instruction to initiate a video stream and an instruction to halt a video stream.

10. A system as in claim 9, wherein the instruction to initiate a video stream and the instruction to halt a video stream each being sent in response to a request from one of the qualified web clients.

11. A system as in claim 1, wherein the one or more video sources comprise at least one camera having incorporated therein one or more sensors each providing an output value readable by the device server.

12. A system as in claim 11, wherein the camera further comprises an application program that interacts with the device server over the control interface and accesses resources provided on the camera.

13. A system as in claim 11, wherein the one or more sensors comprise at least one location determination system, and at least one of an accelerometer, a thermometer and a clock.

14. A system as in claim 13, wherein the output values of location determination system comprise coordinates representing instantaneous geographical locations of the camera, and wherein the application program is configured to provide each video stream with the coordinates embedded therein.

15. A system as in claim 14, wherein the application program further embeds in the video stream contemporaneously generated timestamps at predetermined time intervals.

16. A system as in claim 14, wherein the camera incorporates therein an identification code suitable for use in a digital signature, and wherein the application program includes in the location embedded video stream digital signatures derived from the authentication code.

17. A system as in claim 12, wherein application program further comprises a user interface through which a user of the camera to registers the camera with the system.

18. A system as in claim 17, wherein the user interface allows a user to generate a universal resource locator (url) that can be used to access a video stream initiated by the camera, and wherein the user interface further allows a user at the camera to transmit the url electronically to a viewer, so as to allow the user to access the video stream.

19. A system as in claim 1, wherein the application server derives system metrics from the system data.

20. A system as in claim 19, wherein the metrics comprise usage statistics.

21. A system as in claim 19, wherein the metrics comprise a ranking of the video sources.

22. A system as in claim 1, wherein at least one of the web clients accesses the system through a widget provided in a web page of a third party.

23. A system as in claim 22, wherein the widget is identified by an identifier and wherein the system data include data collected in conjunction with usage of the widget.

24. A camera comprising:
optical elements providing a sequence of video images;
a global positioning system (GPS) receiver providing GPS coordinates representing the instantaneous locations of the camera; and
an encoder receiving the video images and the GPS coordinates, the encoder encoding the video images into a video stream in accordance with an encoding standard and embedding the GPS coordinates into the video stream at information slots provided under the encoding standard.

25. A camera as in claim 24, wherein the encoder further embeds in the video stream contemporaneously generated timestamps at predetermined time intervals.

26. A camera as in claim 24, wherein the camera incorporates therein an identification code suitable for use in a digital signature, and wherein the application program includes in the GPS embedded video stream digital signatures derived from the authentication code.

27. A method for authenticating spatial and temporal information regarding events recorded in a video stream, comprising:
providing a global positioning system (GPS) receiver in a camera, the GPS receiver being configured to provide during operation of the camera GPS coordinates representing the instantaneous locations of the camera;
capturing in the camera a sequence of video images; and
encoding the sequence of video image and the GPS coordinates into a video stream in accordance with an encoding standard, embedding the GPS coordinates into the video stream at information slots provided under the encoding standard.

28. A method as in claim 27, wherein the encoding further embeds in the video stream contemporaneously generated timestamps at predetermined time intervals.

29. A method as in claim 27, wherein the camera incorporates therein an identification code suitable for use in a digital signature, and wherein the encoding includes in the GPS embedded video stream digital signatures derived from the authentication code.

30. A method for providing a network of multiple live video sources, comprising:
configuring a device server having a control interface that exchanges control signals with each of one or more of the video sources, each video source providing a video stream in accordance with control data received at the device server;
configuring an application server that allows controlled access of the network by qualified web clients and providing the control data to the device server in response to data input received from the web clients;
configuring a streaming server which, under direction of the application server, routes the video streams from the one or more video sources to the qualified web clients; and
providing a database system for system data that are accessible by the application server in conjunction with providing service to the web clients.

31. A method as in claim 30, further comprising providing a cache system for the database system.

32. A method as in claim 30, wherein the system data comprises one or more of the following data categories: (a) data collected automatically from sensors related to the video sources; (b) data collected from external input or from content review of the video sources; and (c) data resulting from analysis of data in data categories (a) and (b).

33. A method in claim 32, the system data comprises a categorization of the video sources based on content review.

34. A method as in claim 32, wherein the system data further comprises user profile data.

35. A method as in claim 34, wherein the user profile data includes data collected on users based on their usage of the system.

36. A method as in claim 34, further comprising implementing access control and facilitation to video sources and associated system data based at least in part on the user profile data and a categorization of the video sources based on content review.

37. A method as in claim 30, wherein the control data comprises an instruction to initiate a video stream and an instruction to halt a video stream.

38. A method as in claim 32, wherein the instruction to initiate a video stream and the instruction to halt a video stream each being sent in response to a request from one of the qualified web clients.

39. A method as in claim 30, wherein the one or more video sources comprise at least one camera having incorporated therein one or more sensors each providing an output value readable by the device server.

40. A method as in claim 39, wherein the camera further comprises an application program that interacts with the device server over the control interface and accesses resources provided on the camera.

41. A method as in claim 39, wherein the one or more sensors comprise at least one location determination system, and at least one of an accelerometer, a thermometer and a clock.

42. A method as in claim 41, wherein the output values of the location determination system comprise coordinates representing instantaneous geographical locations of the camera, and wherein the application program is configured to provide each video stream with the coordinates embedded therein.

43. A method as in claim 42, wherein the application program further embeds in the video stream contemporaneously generated timestamps at predetermined time intervals.

44. A method as in claim 42, wherein the camera incorporates therein an identification code suitable for use in a digital signature, and wherein the application program includes in the location embedded video stream digital signatures derived from the authentication code.

45. A method as in claim 40, wherein the application program further comprises a user interface through which a user of the camera to register the camera with the system.

46. A method as in claim 45, wherein the user interface allows a user to generate a universal resource locator (url) that can be used to access a video stream initiated by the camera, and wherein the user interface further allows a user at the camera to transmit the url electronically to a viewer, so as to allow the user to access the video stream.

47. A method as in claim 30, wherein the application server derives system metrics from the data regarding the operations of the system

48. A method as in claim 47, wherein the metrics comprise usage statistics.

49. A method as in claim 47, wherein the metrics comprise a ranking of the video sources.

50. A method as in claim 30, wherein at least one of the web clients accesses the system through a widget provided in a web page of a third party.

51. A method as in claim 50, wherein the widget is identified by an identifier and wherein the system data include data collected in conjunction with usage of the widget.
